(19) United States
(12) Patent Application Publication
(10) Pub. No.: US 2013/0160886 A1
(43) Pub. Date: Jun. 27, 2013

(54) PIPE SYSTEM WITH ANNULUS UTILIZATION AND MONITORING

(71) Applicant: POLYFLOW, LLC, Oaks, PA (US)

(72) Inventor: John R. Wright, JR., Devon, PA (US)

(73) Assignee: POLYFLOW, LLC, Oaks, PA (US)

(21) Appl. No.: 13/706,788

(22) Filed: Dec. 6, 2012

Related U.S. Application Data
(60) Provisional application No. 61/567,824, filed on Dec. 7, 2011.

(51) Int. Cl. G01M 3/28; F16L 55/16

(52) U.S. Cl. CPC G01M 3/2815; F16L 55/16
USPC 138/97; 73/40.5 R

(57) ABSTRACT

A system for monitoring leakage in a pipe system including a pipe, a flexible tube extending through an inside of the pipe, an end fitting assembly connecting each end of the tube to a corresponding end of the pipe which creates an annulus and a monitoring system for detecting leakage from the tube into the annulus. A method for creating multiple flow paths in an existing pipe is also provided.

### FIELD OF INVENTION

This application is generally related to piping and more particularly related to insertion of tubes into existing pipes.

### BACKGROUND

The exploration and production industry for oil and natural gas involves multiple risks regarding its piping systems. Piping systems experience corrosion and leakage issues, which create environmental, economical, and health risks.

Replacing existing piping systems with new pipe is often cost prohibitive. Replacing existing pipe also creates the risk of further disturbance to the natural surrounding environment. The cost of laying a new pipeline in offshore piping is especially expensive due to the increased number and magnitude of the risks involved. Installation of new pipelines in offshore systems also risks environmental disturbance of the seabed.

Transportation of hazardous material, such as wet sour gas, involves a high level of risk due to corrosion and potentially lethal effects from inhalation. Gas wells typically require their own dehydration units to minimize these risks, increasing costs.

There is also a need to create a duel flow system where one type of fluid flows in the inner pipe and a second fluid flow in the annulus between the inner pipe and the outer pipe. This can be beneficial for containment, such as in the transportation of hazardous materials, as well as for retrofitting existing pipelines with an additional fluid transport pathway without the need for running an entire new line, which can raise environmental issues as well as add cost.

Therefore, a need exists for a safer, more cost-efficient system for replacing piping systems, further, it would be desirable to provide a method for continuously monitoring piping to minimize environmental and safety issues which does not require replacing the entire piping system.

### SUMMARY

Briefly stated, the invention provides a system for intermittent or continuously monitoring for any potential leakage in a pipe system including a pipe, an flexible tube extending through the inside of the pipe, an end fitting assembly connecting each end of the tube to a corresponding end of the pipe which creates an annulus, and a monitoring system for detecting leakage from the tube into the annulus.

Another system is disclosed for creating multiple flow paths in an existing pipe including the existing pipe, a flexible, preferably polymeric, tube inserted inside the existing pipe, end fitting assemblies connecting each end of the tube to a corresponding end of the pipe which creates an annulus, with the end fitting assemblies being configured to allow fluid to flow into the annulus without any intermingling.

A method for retrofitting an existing pipe for leakage monitoring is also disclosed which includes accessing an existing pipe, inserting a tube inside of the existing pipe, sealing each end of the tube to a corresponding end of the existing pipe using end fitting assemblies, creating a sealed annulus between the tube and the existing pipe, connecting a monitoring device to the annulus, and upon transporting a fluid through the tube, detecting with the monitoring device any leakage into the annulus.

Another method is disclosed for creating multiple flow paths in an existing pipe system which includes accessing an existing pipe, inserting a tube inside of the existing pipe, sealing each end of the tube to a corresponding end of the existing pipe using end fitting assemblies, creating a sealed annulus, connecting a fluid flow to the sealed annulus and directing a first fluid to flow into the annulus and a second fluid flow into the tube.

For sake of brevity, this summary does not list all aspects of the present invention, which are described in further detail below.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a cross-sectional view of a portion of one end of the pipe system.

FIG. 2 is a perspective view of one end of the tube during insertion into the pipe.

FIG. 3 is a cross-sectional view of a portion of one end of another embodiment of the pipe system.

### DETAILED DESCRIPTION OF THE PREFERRED EMBODIMENTS

Certain terminology is used in the following description for convenience only and is not limiting. The words “front,” “back,” “left,” “right,” “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

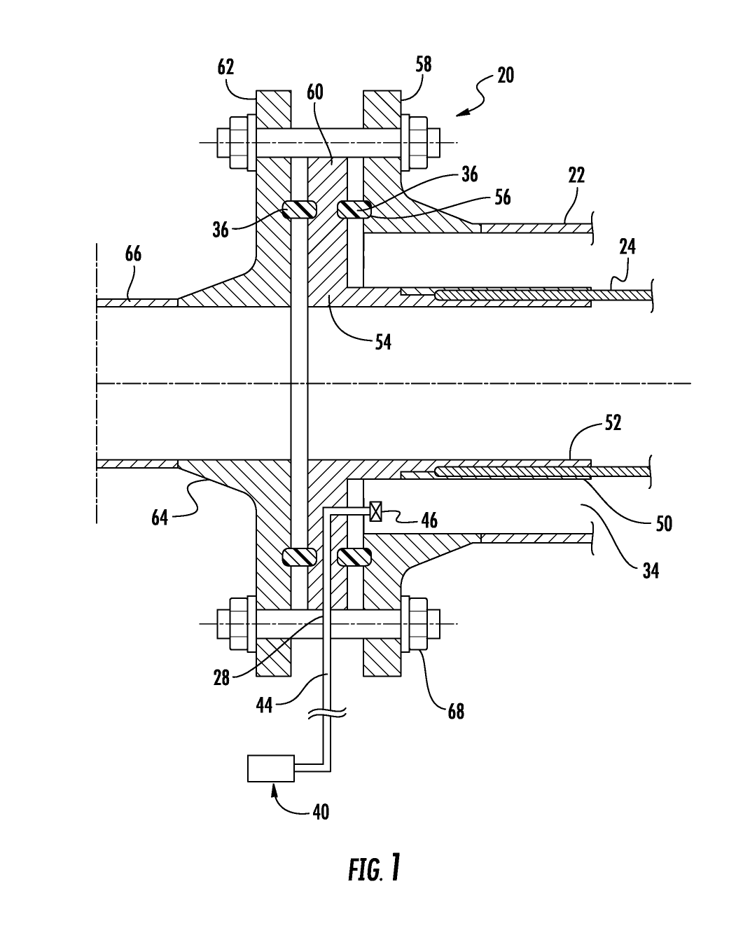

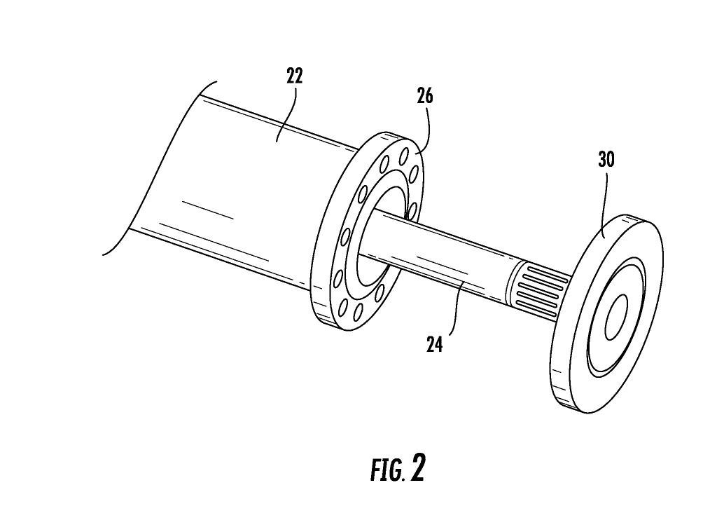

Referring to FIGS. 1 and 2, a pipe system 20 according to the present invention for monitoring leakage is shown. The pipe 22 used in the piping system 20 may be new or existing. The pipe 22 may made be made of a composite material, steel, high density polyethylene (HDPE), polyvinyl chloride (PVC), cement or any other suitable material. The pipe 22 is typically underground, such as at a gas station, a petroleum product well site or refinery or chemical processing plant, but could also be located under a sea bed, above ground or in a factory.

A flexible, preferably polymeric or elastomeric, tube 24 is inserted inside of the pipe 22 and extends from one end to the other. While FIG. 1 shows one end of the system 20 in detail, it will be understood that the other end would be configured in the same manner. The tube 24 can be made of any suitable polymer and/or elastomer or any other material that is flexible and generally compatible with and impermeable to the fluid being transported and which is capable of withstanding the forces associated with installing the tube 24 and the pressures associated with operating the pipe system 20. Preferably, the tube 24 is made of a thermoplastic, such as nylon, or other suitable polymers, and can be reinforced by a braid of aramid or other fibers. A fluid compatible outer jacket is then provided over the braid, with the outer jacket being made of a suitable polymer and/or elastomer that is resistant to any material that will contact an outside of the tube 24.

In one preferred embodiment, the tube 24 is preferably a Thermoflex® tube available from PolyFlow, Inc. in Oaks, Pa. One embodiment of the Thermoflex® tube that was used for testing has a 3″ outer diameter, a 2.53″ inner diameter tube, and a rated at a pressure of 1,500 pounds per square inch (psi). Other sizes can be used depending on the application. The Thermoflex® tube 24 is a multi-layer tube and includes a Fortron™ polyphenylene sulfide (PPS) inner liner, a longitudinal and radial aramid fiber braid and a nylon outer jacket. Such a tube 24 features a long term design strength safety factor of 2.2 and a burst pressure of about 350 bar. This type of tube has good petro-chemical resistance. While the Thermoflex® tube is preferred, those of ordinary skill in the art will recognize that other types of single or multi-layer polymeric and/or elastomeric tubes, with or without reinforcements such as a braided sleeve, can be utilized, depending on the particular application and materials to be transported.

End fitting assemblies capable of securing the ends of the tube 24 to corresponding ends of the pipe 22 are used to create an annulus 34 between the tube 24 and pipe 22. The end fitting assemblies are preferably formed from metallic components and may be coated with a polymer, such as polyphenylene sulfide (PPS) for example in hydrocarbon transport applications. The end fitting assemblies include a pipe flange 58 that is connected to the end of the pipe 22, a connector flange 62 that is connected to a source or receiving system for the fluid being conveyed, and a middle flange 60 attached to the end of the tube 24 that securely engages the tube 24 and creates the annulus 34. The pipe flange 58 can be attached to the end of the existing pipe 22 via welding or any other suitable method. In a preferred embodiment, the pipe flange 58 is made of stainless steel grade 1.4571 and coated with a polymer that is resistant to the material being transported. A gasket or seal 36 for preventing leakage from the annulus 34 is positioned on both axial sides of the middle flange 60. Annular gasket grooves 56 are preferably provided on the surfaces of the pipe flange 58, middle flange 60 and connector flange 62.

The middle flange 60 is preferably formed in one piece with an end fitting 54 for the tube 24. The end fitting 54 includes a tube insert 52 adapted to be inserted inside the end of the tube 24. The tube insert 52 is preferably toothed or stepped. A swaging sleeve or ferrule 50 is provided around the outside of the end of the tube 24. The swaging sleeve or ferrule 50 is preferably made of duplex 2205 stainless steel and its internal surface may also be coated with a suitable polymer, such as Fortron™ The end of the tube 24 is compressed and secured between the swaging sleeve or ferrule 50 and the tube insert 52. To ensure the end fitting 54 is secured to the tube 24, the swaging sleeve or ferrule 50 is preferably pressed onto the end fitting 54 with a force exceeding 100,000 lbs. The swaging sleeve or ferrule 50 firmly presses the end of the tube 24 on the tube insert 52 providing a secure, sealed connection between the tube 24 and the end fitting 54. The flanges 58, 62 preferably include fastener holes to allow for fasteners to extend through the flanges 58, 62, clamping the middle flange 60 and associated gaskets 36 in position therebetween.

Bolts 68 or other fastening means, such as a rivet, screw, clamp, or any other suitable means, are provided to secure the connector flange 62 to the pipe flange 58. A feed tube 66 is attached to the connector flange 62 via welding or any other suitable connection method. The feed tube 66 can be comprised of any suitable material.

An opening 28 can be provided in the middle flange 60 to allow for the connection of a monitoring sensor 46 located in the annulus 34 to a monitoring system 40. The monitoring system 40 detects leakage from the tube 24 into the annulus 34 and is preferably located at an end of the pipe system 20. The monitoring system 40 is connected to the sensor 46 by a wire 44 that extends through the opening 28. Alternatively, the monitoring system 40 may be connected to the annulus 34 via a wire 44 inserted through a sidewall of the pipe 22 or a portion of the flanges 58, 60, 62. The sensor 46 may be a pressure sensor, a detector for various specified materials, a flow sensor, a level sensor or any other suitable type of sensor. Water, packer fluid, glycol mixtures or any other suitable fluid can be used to fill the annulus 34 for monitoring purposes. Nitrogen or any other suitable inert gas could also be used. The monitoring system 40 detects changes in pressure that may indicate a leak or unacceptable level of permeation.

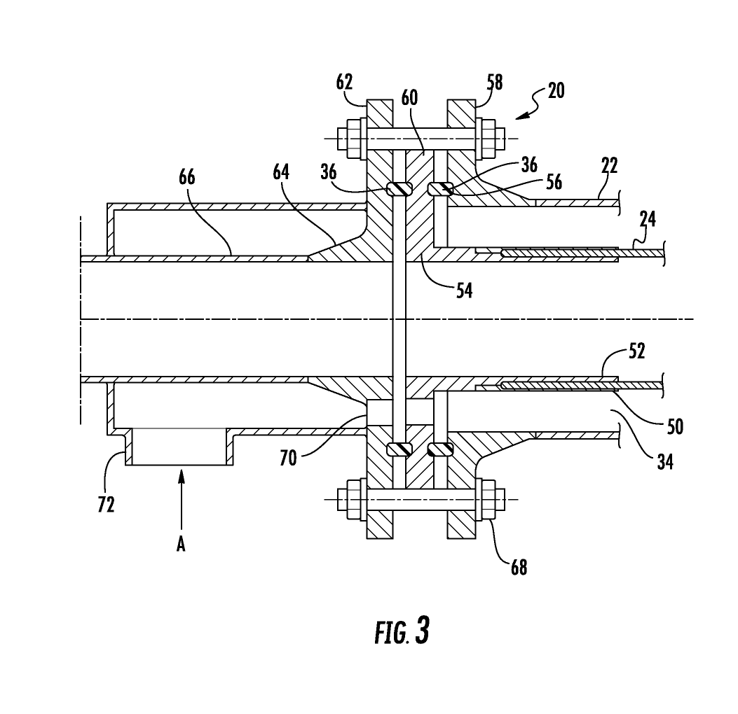

As shown in FIG. 3, in another embodiment, a system for creating multiple flow paths in an existing pipe 22 is created using a similar method as described above with the pipe flange 58 and middle flange 60 that includes the end fitting 54. The flexible tube 24 is inserted into and/or pulled through the pipe 22, which can be for example an existing pipeline, and end fitting assemblies connect both of the ends of the tube 24 to the ends of the pipe 22, creating an annulus 34. A fluid inlet/outlet manifold 72 is attached to or formed with a connection fitting via welding or any other suitable method on the connector flange 62. A fluid flow A enters the annulus 34 via one or more openings 70 in the flanges 60 and 62. Fluid flow in the tube 24 and pipe 22 may be either current or countercurrent to one another. This can be particularly advantageous for retrofitting undersea pipelines with a counterflow path of providing, for example, high pressure gas for a gas lift system, with minimal environmental impact. This arrangement can be utilized to revitalize dead oil wells without the expense of running new pipelines or adding high pressure gas production to an oil rig.

In another embodiment, a method for retrofitting an existing pipe 22 for leakage monitoring is disclosed which includes accessing an existing pipe 22, inserting a tube 24 inside of the existing pipe 22, sealing each end of the tube 24 to a corresponding end of the existing pipe 22 using end fitting assemblies, creating a sealed annulus 34 between the tube 24 and the existing pipe 22, connecting a monitoring system 40 to the annulus 34 and upon transporting a fluid through the tube 24, detecting with the monitoring system 40 any leakage in to the annulus 34.

The tube 24 can be inserted into the pipe 22 via a cable, which is comprised of steel or any other suitable material. A winch is preferably used to pull the tube 24 through the pipe 22. A modified conical shaped buffer may be inserted into the pipe 22 to prevent damage from the pipe's edges to the tube 24 during installation.

In another embodiment, a method for creating multiple flow paths in an existing pipe system 20 is disclosed which includes accessing an existing pipe 22, inserting a tube 24 inside of the existing pipe 22, sealing each end of the tube 24 to a corresponding end of the existing pipe 22 using end fitting assemblies, creating a sealed annulus 34, connecting a fluid flow to the sealed annulus 34 and directing a fluid to flow into the annulus 34. The fluid flow in the annulus 34 may be in either a current or countercurrent direction the flow in the existing pipe 22.

Having thus described various embodiments of the present system and method in detail, it is to be appreciated and will be apparent to those skilled in the art that many physical changes, only a few of which are exemplified in the detailed description above, could be made in the apparatus or method without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A system for monitoring leakage in a pipe system, comprising:
a pipe;
an flexible tube extending through an inside of the pipe;
an end fitting assembly connecting each end of the tube to a corresponding end of the pipe, creating an annulus; and
a monitoring system for detecting leakage from the tube into the annulus.

2. The system according to claim 1, wherein the tube is a reinforced thermoplastic pipe.

3. The system according to claim 1, wherein the end fitting assembly includes a pipe flange connected to the end of the pipe, a middle flange with an end fitting connected to the end of the tube, and a connector flange on an opposite side of the middle flange from the pipe flange.

4. The system according to claim 1, wherein the monitoring system includes a sensor that is connected to the annulus.

5. The system according to claim 1, wherein the monitoring system is connected to the annulus via a wire inserted through an opening in the pipe.

6. The system according to claim 3, wherein the pipe flange, middle flange and connector flange are coated with a polymeric material.

7. The system according to claim 3, wherein a gasket is positioned between both the pipe flange and middle flange and the connector flange and middle flange.

8. A system for creating multiple flow paths in an existing pipe, comprising:
a pipe;
an flexible tube inserted inside the pipe;
end fitting assemblies connecting each end of the tube to a corresponding end of the pipe, creating an annulus; and
the end fitting assemblies configured to allow fluid to flow into the annulus.

9. A method for retrofitting an existing pipe for leakage monitoring, comprising:
accessing an existing pipe;
inserting a tube inside of the existing pipe;
sealing each end of the tube to a corresponding end of the existing pipe using end fitting assemblies, creating a sealed annulus between the tube and the existing pipe;
connecting a monitoring device to the annulus; and
upon transporting a fluid through the tube, detecting with the monitoring device any leakage in the annulus.

10. The method of claim 9, further comprising inserting the tube inside of the existing pipe using a winch.

11. The method of claim 9, wherein the monitoring device is connected to the annulus via a wire inserted through an opening in at least one of the end fitting assemblies.

12. A method for creating multiple flow paths in an existing pipe system, comprising:
accessing an existing pipe;
inserting a tube inside of the existing pipe;
sealing each end of the tube to a corresponding end of the existing pipe using end fitting assemblies, creating a sealed annulus;
connecting a fluid flow to the sealed annulus; and
directing a fluid to flow into the annulus.

13. The method according to claim 12, wherein the fluid flow in the annulus in a countercurrent direction to the flow in the existing pipe.
